(19) United States
(12) Patent Application Publication
(10) Pub. No.: US 2024/0101160 A1
(43) Pub. Date: Mar. 28, 2024

(54) SELF-DRIVING VEHICLE WITH DRIVER TRAINING FACILITY

(71) Applicant: Bulletproof Property Management, LLC, Cheyenne, WY (US)

(72) Inventor: Bennet Langlotz, Dallas, TX (US)

(73) Assignee: Bulletproof Property Management, LLC, Cheyenne, WY (US)

(21) Appl. No.: 17/952,894

(22) Filed: Sep. 26, 2022

(51) Int. Cl. B60W 60/00; B60W 40/09

(52) U.S. Cl. CPC B60W 60/0055; B60W 40/09; B60W 2540/30

(57) ABSTRACT

A vehicle comprises a frame having a drive system with a controller operably connected to the drive system. It also has a compartment having a driver position for a driver and a passenger position for a passenger, with a plurality of vehicle control inputs at the driver position connected to the controller and an interface device configured for communication with the driver. The controller is operable to engage in a training protocol in which the driver is granted progressively increasing control over the vehicle based on driver performance.

### FIELD OF THE INVENTION

The invention relates to self-driving and autonomous vehicles, and hardware and software control systems for such vehicles.

### BACKGROUND AND SUMMARY

Some vehicles have the ability to drive autonomously normally without driver intervention, with the capability or necessity of the driver taking control to override the autonomous or self-driving system for safety or other reasons. Such systems may also operate with full driver control over most vehicle operations, primarily steering, acceleration, braking, and signaling.

Thus, it is necessary to train new drivers as it always has been for manually-controlled vehicles. This need extends to vehicles and other equipment other than private automobiles but with some autonomous operation capabilities including heavy commercial trucks, heavy construction equipment, aircraft, watercraft, spacecraft, and other systems in which human operators and automated control may operate alternatively or in concert.

The above disadvantages are addressed by a vehicle that comprises a frame having a drive system with a controller operably connected to the drive system. It also has a compartment having a driver position for a driver and a passenger position for a passenger, with a plurality of vehicle control inputs at the driver position connected to the controller and an interface device configured for communication with the driver. The controller is operable to engage in a training protocol in which the driver is granted progressively increasing control over the vehicle based on driver performance.

### BRIEF DESCRIPTION OF THE DRAWINGS

FIG. 1 shows a schematic depiction of a vehicle according to a preferred embodiment of the invention.

### DETAILED DESCRIPTION OF A PREFERRED EMBODIMENT

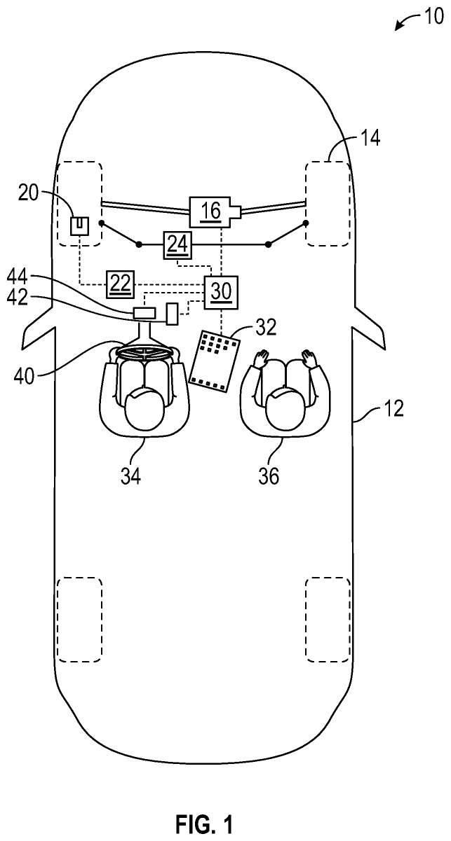

As shown schematically in FIG. 1, the training system operates in a vehicle 10 having a body 12 having wheels 14 that are driven by a motor 16. Brakes 20 are associated with each wheel and a brake cylinder 22 operates the brakes. A steering system 24 steers the front wheels.

A computer or controller 30 is connected to each of the above systems, including sensors to monitor operation of each system, and cameras or other sensors (not shown) that gather information about the vehicle's environment to enable autonomous or assisted driving. A passenger compartment includes a display 32 connected to the controller and visible to a driver 34 and passenger 36 each occupying seats in the compartment. The display provides data entry capability and the controller also connects to audio speakers and microphones in the compartment for sending and receiving audio information with the occupants.

Vehicle controls include a steering wheel or yoke 40 that is connected to the controller and may in some instances be selectably mechanically connected to the steering system 24 to enable direct mechanical control by the driver, electronic control by the driver via the controller, autonomous control by the controller with actuators or the mechanical connection moving the steering wheel in concert with the wheel angle, and combinations of these as selected or indicated by conditions. Similarly, an accelerator pedal 42 and brake pedal 44 are connected respectively to the motor 16, brake system 22, via the controller and optionally with some direct connection for driver and controller control over these functions.

The system normally operates in one of several modes. In manual control, the system is operated entirely by the driver, optionally with the system overriding in an emergency to brake or steer as needed to avoid a collision when the driver appears unable to do so. Autonomous or self-driving mode enables the system to control some or all of the steering, braking, accelerating, and signaling functions based on a selected navigation route. The driver may override some or all self-driving functions and disable the self-driving mode with input to a control (stalk or button), applying brakes, or turning the steering wheel to a different angle to a position different than is established by the system, typically against a distinct detent or resistance force. Manual application of acceleration may override that function, but not cancel self-driving operations.

In the existing system, the driver determines whether to engage a setting that yields control to the vehicle, and when or if to take over control. This rests on the assumption that the driver has superior information and judgment in at least some respects over the automated driving system. The system is subservient to the driver in many situations in which there is a conflict between their control choices. Exceptions to this are typically limited to emergency systems such as collision avoidance, and relate to systems where the vehicle subtly overrides driver inputs with anti-lock braking, traction control, and other measures.

For novice drivers requiring training, traditional methods began with the trainee being a passenger and observing a skilled driver while receiving some instruction. Then, the trainee is entrusted to take over control of the vehicle, possible with limited instructor ability to take over some control such as with a second brake pedal at the passenger position.

In the preferred embodiment, a trainee driver may be monitored, evaluated, guided, instructed and backed up by the automated system.

Initially, the system may orient and familiarize the trainee by the trainee sitting in the driver's seat while the system is driving fully autonomously. By having his hands on the steering wheel, the trainee experiences the feeling of how turns are made, but may have no override capability. Brake and accelerator pedals may optionally move to provide the feel. The system may accompany its driving example with instructions and explanations of how and why it is operating, explaining the principles of driving safety, following distance, how to manage speed when approaching a turn, and such. The system may observe conditions including nearby traffic and make observations about what it is doing (e.g. “I'm accelerating to match the speed of traffic to overtake the white vehicle and merge behind the black vehicle”). The system may also demonstrate techniques such as parallel parking with step-by-step instructions explaining at which points relative to parked vehicles the steering wheel angle is changed to which angles, and such. The system may comment with respect to changing traffic control devices (“I'm slowing now because the light ahead has turned yellow and we are too far to safely cross the intersection”).

After a trainee is oriented with the perspective of a driver but not in command, the system may engage in non-driving audio assessment, quizzing the student on lessons from the orientation or other training. When properly implemented and certified, this may be a substitute for written exams that is satisfactory to regulatory agencies and insurance companies. Imagers and other biometric identifiers in the vehicle may securely ensure the identity of the trainee.

When satisfied that the student is ready, the system may yield some operational control to the student. The system may assess whether the location and traffic are appropriate, first detecting the presence of traffic and other safety factors such as weather and lighting conditions using vehicle cameras and other sensors (not shown). The system may also require input of an authorization code generated by compliance with a third-party qualification process such as passage of a government or insurance written safety test.

If conditions are met, the system may begin by granting limited revocable control of at least one input. The trainee might gain familiarity with braking (or throttle-lift deceleration) inputs (the system prompting to begin braking only after verifying no traffic following too close). This may include normal and emergency braking practice tests. Then it may enable acceleration control to provide familiarity with that function for gentle and hard acceleration. These may be conducted while the vehicle retains steering control. Alternatively, the training may begin with the vehicle proceeding under its own acceleration and braking control, and trainee having only steering control.

The vehicle then can enable trainee steering control in a suitable location after verifying with sensors and checking maps and other data to avoid traffic and hazards nearby or ahead. While the trainee is in control, the system monitors and assesses trainee steering (and other input) performance. If the steering performance departs from an acceptable margin from the steering inputs the system would have applied, or would have considered safe and acceptable, the system may take over control from the student, or may initially instruct and guide the student (e.g. “you're drifting to the right every time an oncoming car approaches—try to remain in the center of your lane”). These are the same inputs a human instructor passenger might give, but the system has the capability to take over control and continue safely driving to give the student a break without pulling off the road. The system may log errors or incidents of system takeover as part of training assessment.

During training, the system may repeatedly asses the student's performance in a series of tasks of increasing difficulty, proceeding only when a task is mastered, or returning to the task as needed.

The passenger may be a teacher, monitor, or parent who can input an instruction to the controller (via screen 32 or a smart phone control) to change the command of the vehicle among trainee, vehicle automatic systems, and the passenger. The passenger may override the vehicle control, whether to enable trainee control to override vehicle control during orientation scenarios, or to prevent the trainee from overriding the system such as if the trainee panics due to stress. The system may also have visual or biomedical sensors to assess trainee condition to anticipate such concerns and take over and pause training if a high heart rate is detected, or visible nervous behaviors, or taking hands off the wheel, for instance.

As training advances, the system uses sensors to assess road and traffic conditions and instruct the student to take certain actions (e.g. “change lanes behind the red car on the left when it's safe”). Instructions may be corrective (“Accelerate harder to match the speed of that truck on the freeway you're entering” or “Slow down!”) When instructions are not properly followed, the system takes over while it determines there is still time to safely make the correction, before it's too late.

In all this, the system monitors the timing, degree, and duration of control inputs, and compares them to a hypothetical ideal (or suitably safe or acceptable range) timing, degree, and duration of control inputs that the system would have made if driving automatically. The system assesses the degree of deviation of actual inputs from hypothetical ideal (or acceptable range limit) inputs, and applies its expertise and rules to assess whether the deviation is tolerable, or requires instructive guidance or requires a warning, or a system takeover of that input or all inputs and whether the takeover is momentarily or prolonged. After any incident (“teachable moment”) the system may interact with the trainee to receive and assess statements by the trainee to verify understanding, and to provide instructions.

When a teacher is present, the system is responsive to the teacher to asses system performance, and appropriate overrides either in favor of system or in favor of the trainee, or in favor of the teacher. The teacher may also be provided with additional inputs for a teacher manual override device (such as passenger smart phone not shown) that may operate like a game controller or otherwise emulate the vehicle controls with a wired or wireless connection to the vehicle controller.

Training may proceed without a teacher, with the system giving the trainee increasing autonomy, independent navigation choices and not merely following specific instructions. Advice may be provided on navigations (“Don't wait too long to merge right to get ready to exit”) in response to traffic and vehicle conditions. The system may report to an authority (parents, insurance company, government) on progress, errors, faults, and serious deviations, and may provide a Safety Score or other feedback to the student to motivate good performance. Motivations may include granting the trainee access to vehicle performance modes, unlocking time of day operations, entertainment operations and volume levels, and geofencing limitations. The vehicle seats may use occupant presence or other sensors to limit and control passenger population, and may monitor interior cameras and microphones to establish access and safety reports on control of distractions such as occupants out of position, driver attention indicators, and conversation noise level. Vehicle systems may monitor phone and other device usage to assess distraction, and may include systems to disable such usage or to disable vehicle operation permissions in response to usage.

The vehicle cameras (interior and exterior) may be triggered to record or save events based on detected driver behavior, performance, and occupant activity.

When in training modes, the vehicle may display external signals or indicia to indicate the training status. These may include alphanumeric displays of information, and operation of vehicle lights to flash or otherwise convey status in a standardized manner that is widely understood. This system may also be invisible to most motorists but discernable to law enforcement patrol vehicles to provide added scrutiny.

I claim:

1. A vehicle comprising:
a frame having drive system;
a controller operably connected to the drive system;
a compartment having a driver position for a driver and a passenger position for a passenger;
a plurality of vehicle control inputs at the driver position connected to the controller;
an interface device configured for communication with the driver;
the controller being operable to engage in a training protocol in which the driver is granted progressively increasing control over the vehicle based on driver performance.

2. The vehicle of claim 1 wherein the controller is responsive to the passenger to enable operation.

3. The vehicle of claim 1 wherein the controller is operable to determine a controller action plan for automatic vehicle operation, and compare the driver actions with the controller action plan.

4. The vehicle of claim 3 wherein the controller is operable to take control from the driver if the driver actions deviate excessively from the controller action plan.

5. The vehicle of claim 3 wherein the controller is operable to correctively instruct the driver if the driver actions deviate excessively from the controller action plan.

6. The vehicle of claim 1 wherein the controller is operable to determine a controller action plan for automatic vehicle operation, and compare the driver actions with the controller action plan.

7. The vehicle of claim 1 wherein the controller is responsive to passenger input to control an operational aspect of the vehicle.

8. The vehicle of claim 8 wherein the controller is operable in response to passenger input to override one of controller command of the vehicle and driver command of the vehicle.

9. The vehicle of claim 1 wherein the controller is operable to share control of the vehicle with the driver including enabling at least one but not all of the vehicle control inputs for driver control, and retaining at least one but not all of the vehicle control, inputs for controller control.

10. A vehicle comprising:
a frame having drive system;
a controller operably connected to the drive system;
a compartment having a driver position for a driver and a passenger position for a passenger;
a plurality of vehicle control inputs at the driver position connected to the controller;
an interface device configured for communication with the driver;
the controller being operable to selectively share vehicle control among the controller, the driver, and the passenger.

11. The vehicle of claim 11 wherein the controller is operable to engage in a training protocol in which the driver is granted control over the vehicle based on passenger input.

12. The vehicle of claim 11 wherein the controller is responsive to the passenger to enable operation.

13. The vehicle of claim 11 wherein the controller is operable to determine a controller action plan for automatic vehicle operation, and compare the driver actions with the controller action plan.

14. The vehicle of claim 11 wherein the controller is operable in response to passenger input to allocate a degree of shared driving control between the driver and the controller.

15. The vehicle of claim 11 wherein the controller is operable in response to passenger input to revoke vehicle control from the vehicle in favor of the controller.

16. The vehicle of claim 11 wherein the controller is operable in response to passenger input to revoke vehicle control from the controller in favor of the driver.

17. The vehicle of claim 11 wherein the controller is responsive to passenger input to control a vehicle control input.

18. The vehicle of claim 17 wherein the controller is operable to override one of controller command of the vehicle and driver command of the vehicle.

19. The vehicle of claim 11 wherein the controller is operable to share control of the vehicle with the driver including enabling at least one but not all of the vehicle control inputs for driver control, and retaining at least one but not all of the vehicle control, inputs for controller control.

20. The vehicle of claim 11 wherein the controller is operable to selectively share vehicle control among the controller, the driver, and the passenger.
